(19) United States
(12) Patent Application Publication
(10) Pub. No.: US 2011/0005426 A1
(43) Pub. Date: Jan. 13, 2011

(54) RECORDING LIQUID

(75) Inventors: Yasuhiro Tanaka, Kanagawa (JP); Ikuko Tsurui, Kanagawa (JP)

Correspondence Address: SNR DENTON US LLP, P.O. BOX 061080, CHICAGO, IL, 60606-1080, US

(73) Assignee: SONY CORPORATION, Tokyo (JP)

(21) Appl. No.: 12/826,184

(22) Filed: Jun. 29, 2010

(30) Foreign Application Priority Data
Jul. 8, 2009 (JP) 2009-161954

(51) Int. Cl. C09D 11/02

(52) U.S. Cl. 106/31.13

(57) ABSTRACT

A recording liquid ejected contains 70% by mass to less than 90% by mass of water, glycerol, a coloring agent, and a compound having a hydroxy group in an amount satisfying relationship: 0.25<y<S₆₀÷2500. The compound is solid at ordinary temperature and pressure and satisfied relationships: Q₂₀<−10 and S₆₀−S₂₀>10. In the relationships, Q₂₀ represents a heat of dissolution of the compound in water at 20° C. and 10³ hPa on a KJ/mol basis, S₂₀ represents the solubility of the compound at 20° C. in water, S₆₀ represents the solubility of the compound at 60° C. in water, and Y represents the content of the compound.

### BACKGROUND OF THE INVENTION

1. Field of the Invention

The present invention relates to a recording liquid used in a recording method for recording by ejecting liquid in droplets.

2. Description of the Related Art

Ink jet recording is known as a recording method for recording by ejecting a recording liquid in droplets. In the ink jet recording method, ink is ejected as the recording liquid to record images and text. In this method, small droplets of ink are ejected onto a recording medium, such as paper, cloth or a film, from nozzles of an ink jet head in a printer apparatus, thus forming images or characters on the recording medium.

For ejecting ink, the ink jet recording method uses electrostatic attraction (charge control method), oscillation pressure of a piezoelectric element, or heat (thermal ink jet method) for forming and growing bubbles to generate pressure. The ink jet recording method can eject very small ink droplets by these techniques, and accordingly can print extremely precise images and characters.

For ink jet recording, inks having specific properties are used. Among those is liquid stability. When ink ejection is restarted after suspension of recording or after a long-term halt, it is desirable that the ink be not deposited to clog nozzle apertures or fine flow channels from the ink reservoir to the nozzles.

The deposit produced in the nozzle apertures or the flow channels by the suspension of recording or by leaving the printer apparatus halting for a long term can hamper the ejection of the ink. In order to prevent such problems, some approaches have been proposed, such as an ink not causing deposit in nozzle apertures or flow channels and a mechanism like a capping mechanism recovering the ink ejection.

Capping is a technique for sealing the spouts of the liquid ejection head with caps such as elastic members, and thus prevents the evaporation of ink and the deposition of foreign matter on nozzle surfaces. For capping, it has been proposed that an absorber containing water be provided within the cap to increase the humidity so as to increase the water content in the thickened ink in the nozzle. The viscosity of the ink is thus reduced for easy ejection.

In the ink jet printer apparatus, if the ink is not ejected through a nozzle for a while, even for a time as short as several seconds, the nozzle can be clogged or the ink around the nozzle can be thickened. This problem can occur if the ink is thickened, even in ink jet printer apparatuses operated by other systems using, for example, piezoelectric elements or heat resistors. To prevent this problem, many printers take a recovery measure called pre-ejection or idle ejection.

Pre-ejection is to eject ink not involved in printing from the ejection head so as to recover ink ejection conditions. The pre-ejection is performed when the ink around some of the nozzles is thickened due to an elapse of a certain time without sealing with the cap. The pre-ejection thus can eliminate the problems of reducing the ejection speed to vary the ejection direction, and of fluctuating the amount of ejected ink. In addition, the pre-ejection can eliminate the problem of color mixture caused in the nozzles of recording heads capable of ejecting a plurality of color inks after forced ejection or wiping.

Unfortunately, pre-ejection or idle ejection can cause many problems particularly in line printer apparatuses. A serial printer apparatus prints a line while the head including nozzles through which ink is ejected is moving in the direction of the width of recording paper. After printing the single line, the recording paper is transported in a predetermined direction to displace the print position by a predetermined distance, and then the next line is thus printed while the head is moving in the width direction of the recording paper. Since the head of the serial printer apparatus moves intrinsically in the width direction of the recording paper, a pre-ejection absorber can be disposed in the direction in which the head moves. Thus, the serial printer apparatus can easily perform pre-ejection during printing.

On the other hand, the liquid ejection head of line printer apparatuses has substantially the same width as recording paper, and accordingly can print a line without moving the head in the width direction of the recording paper. Consequently, line printer apparatuses can print faster than serial printer apparatuses, which print lines by moving the liquid ejection head in the width direction of the recording paper.

In many of the line printer apparatuses, however, when the recording paper is transported to a position opposing the liquid ejection head, the ejection surface of the liquid ejection head is wiped and covered with a cap, and pre-ejection is performed toward a pre-ejection absorber in the cap. Printing operation is thus temporally suspended for a while, and consequently, printing time is increased.

Measures for recovery from suspension of printing are taken in the ink composition and the printer phosphorus. In order to prepare an ink composition not causing clogging in the nozzles and exhibiting superior ejection stability even after restating the printing, various additives have been proposed.

Japanese Patent No. 3846683 proposes an ink composition containing a coloring agent, water, a water-soluble organic solvent, and a mixture of sugars. This ink composition is designed in view of long-term storage, and does not allow for ejection failure caused by momentary evaporation increasing the viscosity. Accordingly, measures for pre-ejection or idle ejection of printer apparatuses are rather taken than for ink compositions.

For example, Japanese Examined Patent Application Publication No. 03-59832 proposes a technique using idle ejection. However, maintenance of the liquid ejection head during printing, including pre-ejection, reduces the printing speed, and increases the size of the printer apparatus by the volumetric capacity of an idle ejection receiver or a waste container.

In particular, line printer apparatuses have a liquid ejection head having substantially the same width as the recording paper. Accordingly, for idle ejection, a mechanism or a space is provided with which the entire liquid ejection head can move away from the position opposing the recording paper. Furthermore, it takes a time to move a large liquid ejection head for maintenance, such as idle ejection. Thus, the printing time is increased, and, consequently, the running cost is increased.

In order to solve this problem, the liquid ejection head may keep ejecting ink without performing idle ejection, and hence without moving the liquid ejection head away from the position opposing the recording paper. For example, Japanese Unexamined Patent Application Publication No. 6-40042 discloses that nozzles through which ink have been ejected few times are subjected to pre-ejection to the extent that the ejected ink is not shown on the recording paper under printing. Japanese Unexamined Patent Application Publication NO. 2009-12283 proposes that pre-ejection be performed for forming electronic watermarks on recording paper.

Unfortunately, the amount of pre-ejection ink to be ejected onto the recording paper and the pre-ejection conditions are limited, and complex treatment is performed for electronic watermarks or the like. Accordingly, ink jet printer apparatuses generally repeat pre-ejection operations within several seconds in practice.

For enhancing the stability in intermittent ejection, Japanese Unexamined Patent Application Publication No. 11-302584 proposes that a sugar, a sugar derivative or a sugar alcohol be used as a moisturizing agent in a system containing a self-dispersing carbon black as a color material. However, the ink composition disclosed in this patent document is applied to only the cases of using carbon black as the color material and is not applied to other cases of using other color materials, thus limiting the coverage.

### SUMMARY OF THE INVENTION

Accordingly, it is desirable to provide a recording liquid that can be properly ejected without performing pre-ejection or idle ejection during printing operation and thus can produce good printed matter.

A recording liquid according to an embodiment of the present invention is ejected by a liquid ejection apparatus including a liquid ejection head having a nozzle through which the recording liquid is ejected and a heating mechanism heating the recording liquid around the nozzle to about 60° C. The recording liquid contains: 70% to less than 90% by mass of water; glycerol; a coloring agent soluble or dispersible in the water; and 0.25% to 3.0% by mass of xylitol.

A recording liquid according to another embodiment of the present invention, which is also ejected by the liquid ejection apparatus, contains 70% to less than 90% by mass of water; glycerol; a coloring agent soluble or dispersible in the water; and 0.25% to 2.0% by mass of erythritol.

A recording liquid according to still another embodiment of the present invention, which is also ejected by the liquid ejection apparatus, contains 70% to less than 90% by mass of water; glycerol; a coloring agent soluble or dispersible in the water; and 0.5% to 1.0% by mass of D-mannitol.

A recording liquid according to still another embodiment of the present invention, which is also ejected by the liquid ejection apparatus, contains: 70% to less than 90% by mass of water; glycerol; a coloring agent soluble or dispersible in the water; and a compound having a hydroxy group in an amount satisfying relationship (3). The compound is solid at ordinary temperature and pressure and satisfies the following relationships (1) and (2):

Q₂₀<−10 (1)

S₆₀−S₂₀>10 (2)

0.25<Y<S₆₀÷2500 (3)

(Q₂₀ represents a heat of dissolution of the compound in water at 20° C. and 10³ hPa on a KJ/mol basis, S₂₀ represents the solubility of the compound at 20° C. in water, S₆₀ represents the solubility of the compound at 60° C. in water, and Y represents the content of the compound on a percent by mass basis. The solubility refers to the mass on a gram basis of the compound in 100 g of saturated solution of the compound.)

A recording liquid contains 70% to less than 90% by mass of water, glycerol, a coloring agent soluble or dispersible in the water, and 0.25% to 3.0% by mass of xylitol. By using this recording liquid in a liquid ejection apparatus including a liquid ejection head having a nozzle through which the recording liquid is ejected and a heating mechanism heating the recording liquid around the nozzle to about 60° C., proper ink ejection can be performed without pre-ejection or idle ejection during recording operation.

A recording liquid contains 70% to less than 90% by mass of water, glycerol, a coloring agent soluble or dispersible in the water, and 0.25% to 2.0% by mass of erythritol. By using this recording liquid in a liquid ejection apparatus including a liquid ejection head having a nozzle through which the recording liquid is ejected and a heating mechanism heating the recording liquid around the nozzle to about 60° C., proper ink ejection can be performed without pre-ejection or idle ejection during recording operation.

A recording liquid contains 70% to less than 90% by mass of water, glycerol, a coloring agent soluble or dispersible in the water, and 0.5% to 1.0% by mass of D-mannitol. By using this recording liquid in a liquid ejection apparatus including a liquid ejection head having a nozzle through which the recording liquid is ejected and a heating mechanism heating the recording liquid around the nozzle to about 60° C., proper ink ejection can be performed without pre-ejection or idle ejection during recording operation.

A recording liquid contains 70% to less than 90% by mass of water, glycerol, a coloring agent soluble or dispersible in the water, and a compound in an amount satisfying relationship (3) which is solid at ordinary temperature and pressure, has a hydroxy group and satisfies the following relationships (1) and (2). By using this recording liquid in a liquid ejection apparatus including a liquid ejection head having a nozzle through which the recording liquid is ejected and a heating mechanism heating the recording liquid around the nozzle to about 60° C., proper ink ejection can be performed without pre-ejection or idle ejection during recording operation.

Q₂₀<−10 (1)

S₆₀−S₂₀>10 (2)

0.25<Y<S₆₀÷2500 (3)

### BRIEF DESCRIPTION OF THE DRAWINGS

FIG. 1 is a perspective view of a liquid ejection apparatus using a recording liquid according to an embodiment of the present invention;

FIG. 2 is a perspective view of a liquid ejection head of the liquid ejection apparatus;

FIG. 3 is a sectional view of the liquid ejection head;

FIG. 4A is a sectional view of the liquid ejection head in a state where air bubbles are produced at a heat resistor, and FIG. 4B is a schematic sectional view of the liquid ejection head in a state where a recording liquid is ejected through a nozzle;

FIG. 5 is a transparent side view of the liquid ejection apparatus;

FIG. 6 is a plot showing the relationship between the xylitol content and the non-ejection period after which good printed matter was produced;

FIG. 7 is a plot showing the relationship between the erythritol content and the non-ejection period after which good printed matter was produced; and

FIG. 8 is a plot showing the relationship between the D-mannitol content and the non-ejection period after which good printed matter was produced.

### DESCRIPTION OF THE PREFERRED EMBODIMENTS

Recording liquids according to embodiments of the invention will be described in detail with reference to the drawings. The description will be made in the following order:

1. Printer apparatus

(1) Head cartridge

(2) Head cap

(3) Apparatus body

(4) Operation of printer apparatus

2. Recording liquid

(1) Solvent

(2) Coloring agent

(3) Specific compound

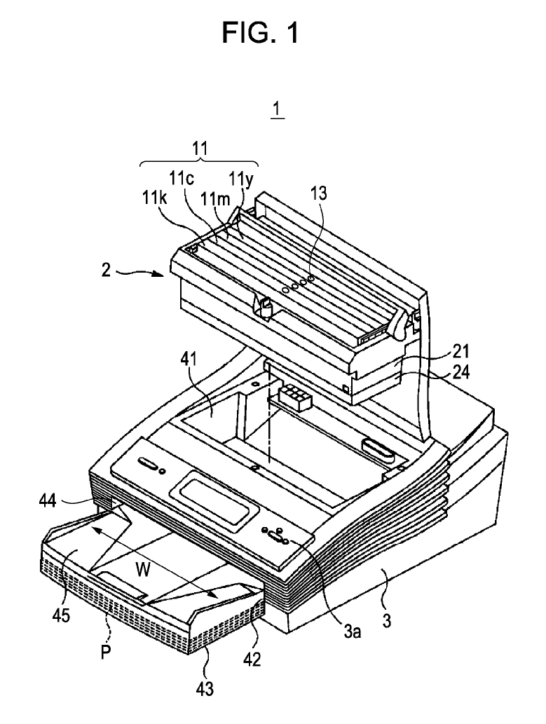

A recording liquid according to an embodiment of the invention is used in an ink jet printer apparatus 1 (hereinafter referred to as the printer apparatus 1) as shown in, for example, FIG. 1. The printer apparatus 1 can print color images and characters using, for example, four color recording liquids i, or inks i, of yellow, magenta, cyan, and black. In the following description, the printer apparatus will first be described and then inks i according to embodiments of the invention will be described.

### 1. Printer Apparatus

The printer apparatus 1 will be described in detail. As shown in FIG. 1, the printer apparatus 1 includes an ink jet printer head cartridge (hereinafter referred to as head cartridge) 2 from which inks i are ejected onto a recording medium, such as recording paper P, and an apparatus body 3 to which the head cartridge 2 is attached. The printer apparatus 1 is a so-called line printer apparatus, which has nozzles arranged at least one line extending in the direction of the width of the recording paper P, that is, in the direction W indicated by an arrow in FIG. 1. In the printer apparatus 1, the head cartridge 2 is removable from the apparatus body 3.

### (1) Head Cartridge

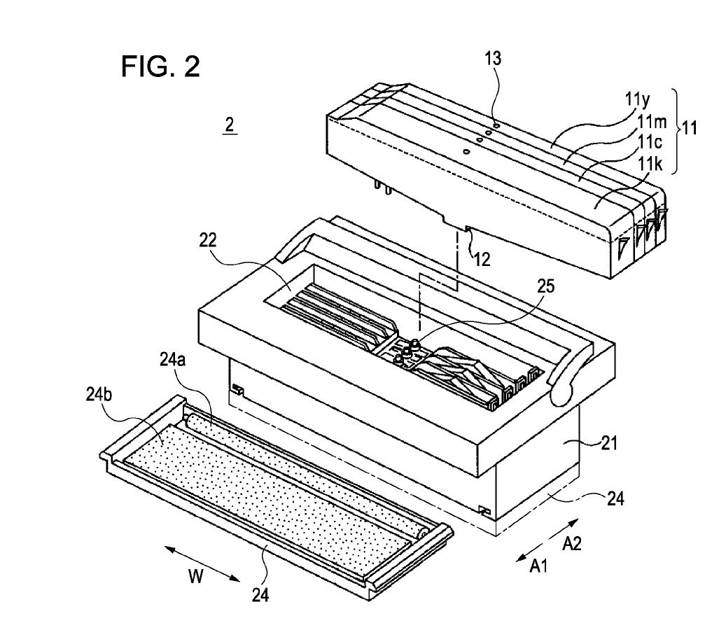

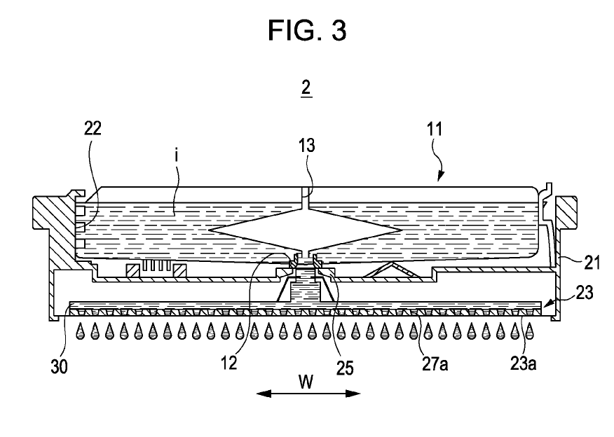

The head cartridge 2 of the printer apparatus 1 will now be described. The head cartridge 2 ejects inks i onto the main surface of the recording paper P, using an electrothermal conversion heat resistor as a pressure generating element. The head cartridge 2 includes ink cartridges 11 each containing an ink i, as shown in FIGS. 2 and 3.

The ink cartridges 11 include a yellow ink cartridge 11y, a magenta ink cartridge 11m, a cyan ink cartridge 11c, and a black ink cartridge 11k. The ink cartridges 11 are substantially rectangular and have substantially the same width as the recording paper P. Each ink cartridge 11 has an ink supply portion 12 through which the ink i is supplied to the cartridge body 21 of the head cartridge 2, and an external communication hole 13 at substantially the center on the upper side through which air is taken from the atmosphere after the ink i has been supplied to the cartridge body 21, as shown in FIGS. 2 and 3. The head cartridge 2 and the ink cartridges 11 may be integrated into one body.

The ink supply portion 12 is provided at substantially the center on the bottom side of the ink cartridge 11. The ink supply portion 12 is a protruding nozzle. The end of the nozzle is engaged in the below-described corresponding joint 25 of the head cartridge 2, thus combining the ink cartridge 11 with the cartridge body 21 of the head cartridge 2 for ink supply. The ink supply portion 12 includes a valve structure controlling the supply of the ink i to the cartridge body 21.

The head cartridge 2 to which the ink cartridge 11 is attached includes the cartridge body 21, as shown in FIGS. 2 and 3. The cartridge body 21 has an attachment 22 in which the ink cartridge 11 is fitted, an ink ejection head 23 from which the ink i is ejected, and a head cap 24 protecting the ink ejection head 23.

The joints 25 are provided at substantially the center of the attachment 22, and with which the ink supply portions 12 of the ink cartridges 11 fitted in the attachment 22 are connected. The joint 25 is to act as an ink supply channel through which the ink i is supplied to the ink ejection head 23 provided at the bottom of the cartridge body 21 through the ink supply portion 12 of the ink cartridge 11 in the attachment 22. The joint 25 controls the supply of the ink i from the ink cartridge 11 to the ink ejection head 23 by its valve structure.

The ink ejection head 23 to which the ink i is supplied through the joint 25 is disposed along the bottom of the cartridge body 21. The ink ejection head 23 has nozzles 27a (described later) through which the ink i supplied through the joint 25 is ejected. The nozzles 27a for the same color are disposed in a line in the direction of the width of the recording paper P, that is, the direction indicated by the arrow W shown in FIG. 3, and lines of the nozzles 27a are arranged for the respective colors. For ejecting inks i, the ink ejection head 23 ejects inks i through the respective nozzle lines one after another without moving in the width direction of the recording paper P.

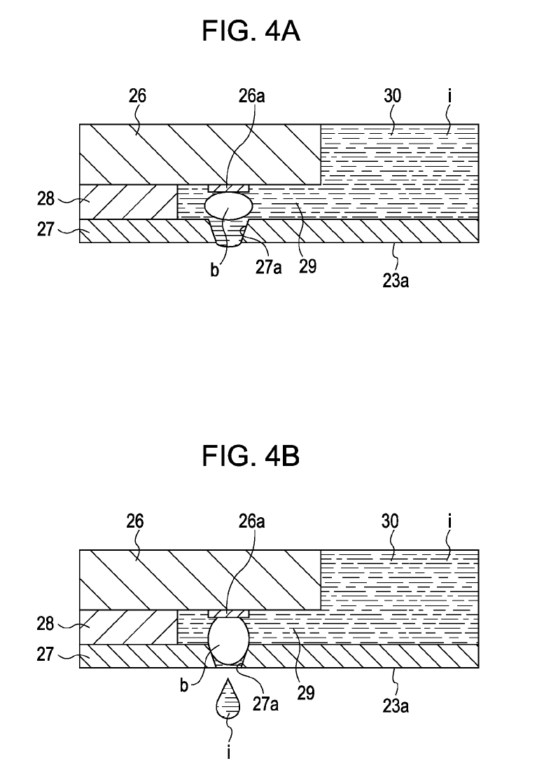

As shown in FIGS. 4A and 4B, the ink ejection head 23 includes a circuit board 26 having an electrothermal conversion heat resistor 26a, a nozzle sheet 27 in which nozzles 27a are formed, and a film 28 disposed between the circuit board 26 and the nozzle sheet 27. In the ink ejection head 23, an ink chamber 29 is defined by the circuit board 26, the nozzle sheet 27 and the film 28. The ink chamber 29 is filled with the ink i, which is to be heated with the heat resistor 26a. The ink ejection head 23 also has an ink flow channel 30 through which the ink i is delivered to the ink chamber 29 from the ink cartridge 11.

In the ink ejection head 23, the control circuit of the circuit board 26 applies a pulsed current selectively to the heat resistors 26a in response to a recording signal according to printing data so that the corresponding heat resistor 26a heats. When the heat resistor 26a heats, an air bubble is formed in the ink i in contact with the heat resistor 26a, as shown in FIG. 4A. The air bubble expands to press the ink i, and the pressed ink i is formed into a droplet and ejected through the nozzle 27a, as shown in FIG. 4B. After ejecting the droplet of the ink i, the ink i is supplied to the ink chamber 29 through the ink flow channel 30. Thus, the ink ejection head 23 is returned to the state before ejection. The ink ejection head 23 repeats the above operation in response to the recording signal according to the printing data, thus ejecting the ink i onto a recording paper P to print images and characters.

If the image or character to be printed have a blank area, the nozzle 27a corresponding to the blank area does not eject the ink i. If one or some of the nozzles 27a do not eject the ink i even for a short time because of the presence of a blank area, the ink i at the end of and inside such nozzles 27a is dried to thicken. Accordingly, in the ink ejection head 23 according to the present embodiment, the thickened ink i is heated to 60° C. with the heat resistor 26a so as to reduce the viscosity before restarting the ejection of the ink i through the nozzle 27a that has been under suspension. The temperature of 60° C. is a preheating temperature to which the ink i is heated to reduce the viscosity of the ink i without being ejected through the nozzle 27a. By preheating the ink i to 60° C., the ink i is prevented from failing in ejection and from being ejected in a direction diverging from an intended direction when the ejection of ink i is restarted through nozzles 27a that have not ejected ink i for a short time.

Although in the ink ejection head 23, the heat resistor 26a heats the thickened ink i to 60° C. in the present embodiment, any heating mechanism can be provided at the vicinity of the nozzle 27a for heating the thickened ink i without being limited to the heat resistor 26a. In the ink ejection head 23, any other heating mechanism may reduce the viscosity of the thickened ink i by heating the ink i to 60° C.

In addition, a humidifier may be provided to the ink ejection head 23 so that even if the ink i is seriously thickened by still longer suspension of ink ejection, proper printing can be achieved simply by pre-ejection without removing the thickened ink i by suction or wiping with a cleaning roller 24a.

### (2) Head Cap

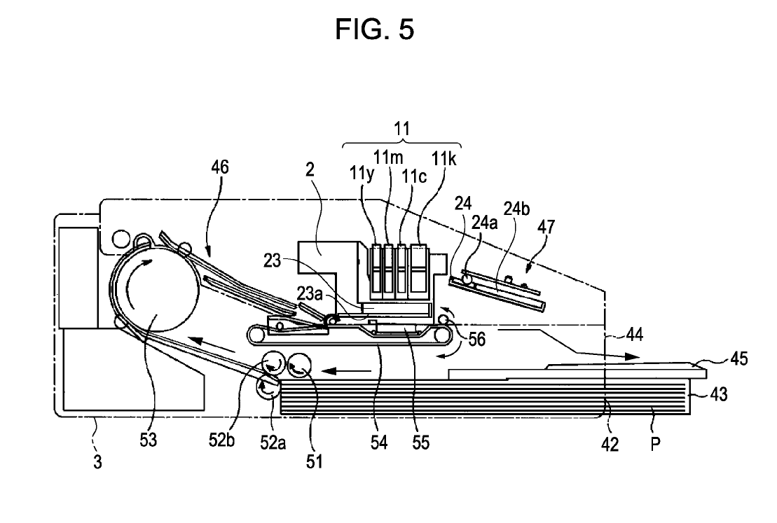

As shown in FIG. 2, a head cap 24 protecting the ejection surface 23a of the ink ejection head 23 covers the ejection surface 23a to prevent the nozzles 27a from drying during long-time suspension of ink ejection. For printing, the head cap 24 is moved forward from the bottom of the head cartridge 2, that is, in the direction indicated by arrow A1 shown in FIG. 2, to expose the ejection surface 23a of the ink ejection head 23, as shown in FIGS. 2 and 5. After printing, the head cap 24 is moved to the bottom of the head cartridge 2, that is, in the direction indicated by arrow A2 shown in FIG. 2, to protect the ejection surface 23a of the ink ejection head 23, as shown in FIG. 2.

The head cap 24 has a cleaning roller 24a for wiping the excess of the ink i off the ejection surface 23a. When the head cap 24 is opened to expose the ejection surface 23a, the cleaning roller 24a wipes the excess of the ink i off the ejection surface 23a to absorb it. Alternatively, when the head cap 24 is moved to the bottom of the head cartridge 2 after printing, the cleaning roller 24a may wipe the ejection surface 23a.

The head cap 24 may have an absorber 24b for absorbing the ink i discharged by idle ejection after long-time suspension of ink ejection with the ejection surface 23a protected. The cleaning with the cleaning roller 24a and the idle ejection are effective in removing the thickened ink i in the nozzle 27a after a long-term halt in printing.

### (3) Apparatus Body

The apparatus body 3 to which the head cartridge 2 is installed has a head cartridge attachment 41 in which the head cartridge 2 is fitted, as shown in FIG. 1. A paper feed tray 43 in which stack of many pieces of recording paper to be printed is accommodated is attached to the paper feed port 42 provided at the front and lower position of the apparatus body 3, and a paper ejection tray 45 in which printed paper P is to be accommodated is attached to a paper ejection port 44 at the front and upper position of the apparatus body 3.

Turning to FIG. 5, the apparatus body 3 includes a paper feed/ejection mechanism 46 transporting recording paper P, and a cap removing mechanism 47 removing and attaching the head cap 24, disposed at the ejection surface 23a of the ink ejection head 23.

### (4) Operation of Printer Apparatus

The printer apparatus 1 prints images and characters according to printing data transmitted from the external information processing apparatus. More specifically, in the printer apparatus 1, the head cap removing mechanism 47 moves the head cap 24 from the head cartridge 2 toward the front of the apparatus body 3 to which the feed tray 43 and the paper ejection tray 45 are attached. The nozzles 27a provided in the ejection surface 23a of the ink ejection head 23 are thus exposed for ejection of the ink i. In the printer apparatus 1, the thickened ink i may be discharged by idle ejection in the head cap 24 before moving the head cap 24 toward the front of the apparatus body 3, or the ejection surface 23a may be wiped with the cleaning roller 24a when the head cap 24 is moved toward the front of the apparatus body 3.

Then, the paper feed/ejection mechanism 46 of the apparatus body 3 is driven according to the operation of a control button 3a of the apparatus body 3, so that recording paper P is extracted from the feed tray 43 by a feed roller 51 and only a piece of the recording paper P is transported from the feed tray 43 by a pair of separation rollers 52a and 52b rotating in the opposite directions to each other. The piece of recording paper P extracted from the feed tray 43 is reversed toward the head cartridge 2 by a reversing roller 53 and transported to a conveying belt 54 disposed at the position opposing the ejection surface 23a. The recording paper P is supported on a platen 55 disposed at the position opposing the ejection surface 23a of the ink ejection head 23, thus opposing the ejection surface 23a.

Then, the printer apparatus 1 applies a driving current to a plurality of heat resistors 26a provided for each color in the ink ejection head 23, according to a control signal of printing data, and thus the heat resistors 26a heats. By generating heat from the heat resistor 26a, each color ink i is formed into a droplet and ejected through the nozzle 27a onto a piece of the recording paper transported to the position opposing the ejection surface 23a, as shown in FIG. 4. The printer apparatus 1 thus prints monochrome or color images and characters on a recording paper P. The printer apparatus 1 thus can print, for example, an A4-size image or document at a rate of about 12 s/piece.

In the printer apparatus 1, if ink ejection of one or some of the nozzles 27a is suspended because of the presence of a blank area in the image or document to be printed, the heat resistor 26a of the nozzle 27a corresponding to the blank area heats the ink i in this nozzle 27a to 60° C. to reduce the viscosity of the ink i when the ejection through the nozzle 27a is restarted. Thus, the ink i can be properly ejected through the nozzle 27a.

The printed recording paper P is delivered to the paper ejection port 44 by the transport belt 54 rotating in the direction toward the paper ejection port 44 and a paper ejection roller 56 disposed to the paper ejection port side of the ejection surface 23a so as to oppose the transport belt 54, thus being ejected into the paper ejection tray 45.

### 2. Recording Liquid

The ink i used in the above-described printer apparatus 1 will now be described. The ink i contains water, glycerol, a coloring agent soluble or dispersible in water, and a specific compound having a hydroxy group that is solid at ordinary temperature and pressure and satisfies relationships (1) and (2) below.

### (1) Solvent

A mixture of at least water and glycerol is used as the solvent of the ink i. The water is preferably deionized. The water content in the ink i is 70% to less than 90% by mass, and preferably 70% to 85% by mass. The glycerol content in the ink i is 10% to 20% by mass. Such water content and glycerol content can prevent the ink i from drying.

In addition to the mixed solvent, a water-soluble organic solvent may be added. The water-soluble organic solvent may be an aliphatic monohydric alcohol, a polyhydric alcohol, or a polyhydric alcohol derivative.

Examples of the aliphatic monohydric alcohol include lower alcohols such as methyl alcohol, ethyl alcohol, n-propyl alcohol, i-propyl alcohol, n-butyl alcohol, s-butyl alcohol, and t-butyl alcohol.

Examples of the polyhydric alcohol include alkyl glycols such as ethylene glycol, diethylene glycol, triethylene glycol, propylene glycol, butylene glycol, and glycerol; polyalkylene glycols, such as polyethylene glycol and polypropylene glycol; and thiodiglycols.

Examples of the polyhydric alcohol derivative include lower alkyl ethers of the above polyhydric alcohols, such as ethylene glycol dimethyl ether, cellosolve, and diethylene glycol monomethyl ether; and lower carboxylic acid esters of the above polyhydric alcohols, such as ethylene glycol diacetate.

The solvent of the ink i may contain some additives, such as a surfactant, an antifoaming agent, a pH adjuster, and a fungicide. The solvent may optionally contain alcohol amines, such as monotriethanolamine and ditriethanolamine; amides, such as dimethylformamide and dimethyl ketone amide; ketones, such as acetone and methyl ethyl ketone; and ethers such as dioxane.

The solvent may further contain 1,2-alkylene glycol, such as 1,2-pentanediol or 1,2-hexanediol in a proportion of 1% by mass to less than 4% by mass.

### (2) Coloring Agent

A dye may be used as the coloring agent of the ink i. The dye may be soluble in water as represented by direct dyes and acid dyes.

Exemplary direct yellow dyes include C. I. Direct Yellows 1, 8, 11, 12, 24, 26, 23, 24, 28, 31, 33, 37, 39, 44, 46, 62, 63, 75, 79, 80, 81, 83, 84, 89, 95, 99, 113, 27, 50, 58, 85, 86, 88, 98, 100, and 110.

Exemplary direct magenta dyes include C. I. Direct Reds 1, 2, 4, 9, 11, 13, 17, 20, 197, 201, 218, 220, 224, 225, 226, 227, 228, 229, 230, and 321.

Exemplary direct cyan dyes include C. I. Direct Blues 1, 2, 6, 8, 15, 22, 25, 41, 71, 76, 77, 78, 80, 86, 90, 98, 106, 108, 120, 158, 160, 163, 165, 168, 192, 193, 194, 195, 196, 199, 200, 201, 202, 203, 207, 225, 226, 236, 237, 246, 248, and 249.

Exemplary direct black dyes include C. I. Direct Blacks 17, 19, 22, 32, 38, 51, 56, 62, 71, 74, 75, 77, 94, 105, 106, 107, 108, 112, 113, 117, 118, 132, 133, and 146.

Exemplary acid yellow dyes include C. I. Acid Yellows 1, 3, 7, 11, 17, 19, 23, 25, 29, 36, 38, 40, 42, 44, 49, 59, 61, 70, 72, 75, 76, 78, 79, 98, 99, 110, 111, 112, 114, 116, 118, 119, 127, 128, 131, 135, 141, 142, 161, 162, 163, 164, and 165.

Exemplary acid magenta dyes include C. I. Acid Reds 1, 6, 8, 9, 13, 14, 18, 26, 27, 32, 35, 37, 42, 51, 52, 57, 75, 77, 80, 82, 83, 85, 87, 88, 89, 92, 94, 97, 106, 111, 114, 115, 117, 118, 119, 129, 130, 131, 133, 134, 138, 143, 145, 154, 155, 158, 168, 180, 183, 184, 186, 194, 198, 199, 209, 211, 215, 216, 217, 219, 249, 252, 254, 256, 257, 262, 265, 266, 274, 276, 282, 283, 303, 317, 318, 320, 321, and 322.

Exemplary acid cyan dyes include C. I. Acid Blues 1, 7, 9, 15, 22, 23, 25, 27, 29, 40, 41, 43, 45, 54, 59, 60, 62, 72, 74, 78, 80, 82, 83, 90, 92, 93, 100, 102, 103, 104, 112, 113, 117, 120, 126, 127, 129, 130, 131, 138, 140, 142, 143, 151, 154, 158, 161, 166, 167, 168, 170, 171, 175, 182, 183, 184, 187, 192, 199, 203, 204, 205, 229, 234, and 236.

Exemplary acid black dyes include C. I. Acid Blacks 1, 2, 7, 24, 26, 29, 31, 44, 48, 50, 51, 52, 58, 60, 62, 63, 64, 67, 72, 76, 77, 94, 107, 108, 109, 110, 112, 115, 118, 119, 121, 122, 131, 132, 139, 140, 155, 156, 157, 158, 159, and 191.

### (3) Specific Compound

The ink i contains a specific compound satisfying the following relationships (1) and (2). The compound is solid at ordinary temperature and pressure and contains a hydroxy group. The content Y of this compound satisfies the relationship (3). Such compounds include xylitol, erythritol and D-mannitol.

Q₂₀<−10 (1)

S₆₀−S₂₀>10 (2)

0.25<Y<S₆₀÷2500 (3)

In the relationships, Q₂₀ represents a heat of dissolution of the compound in water at 20° C. and 10³ hPa on a KJ/mol basis, S₂₀ represents the solubility of the compound at 20° C. in water, S₆₀ represents the solubility of the compound at 60° C. in water, and Y represents the content of the compound on a percent by mass basis. The solubility mentioned herein refers to the mass on a gram basis of the compound in 100 g of saturated solution of the compound.

As expressed by relationship (1), the compound has a heat of dissolution of less than −10 kJ/mol at 20° C. and 10³ hPa, and its solubility in water differs more than 10% by mass between 20° C. and 60° C. If the ink i is heated to 60° C., the solubility of the compound in the ink i is increased, and accordingly the viscosity of the thickened ink i is reduced. Preferably, the solubility of the compound in water at 20° C. is 60% by mass or more.

The ink i containing the specific compound in an amount satisfying relationship (3) can be ejected properly by being heated to 60° C. with the heat resistor 26a even though it is thickened at the end of the nozzle 27a or inside the nozzle 27a corresponding to the blank area in the image or document to be printed.

Such compounds include xylitol, erythritol and D-mannitol. Table 1 shows the heats of dissolution (Q₂₀) and the solubilities at 20° C. (S₂₀) and at 60° C. (S₆₀) of xylitol, erythritol and D-mannitol.

TABLE 1

| | Q₂₀ | S₂₀ | S₆₀ | S₆₀ - S₂₀ |
|---|---|---|---|---|
| | (KJ/mol) | (mass %) | (mass %) | (mass %) |
| Xylitol | −37 | 61 | 83 | 22 |
| Erythritol | −29 | 16 | 37 | 21 |
| D-mannitol | −43 | 32 | 56 | 24 |
| Maltitol | −6 | 53 | 73 | 20 |
| Sucrose | −5 | 66 | 74 | 8 |

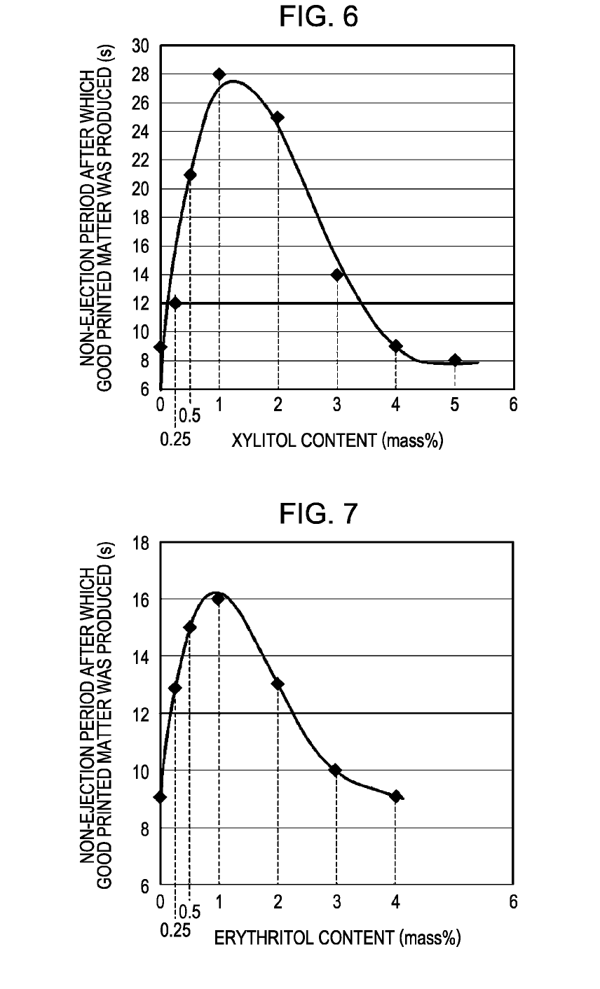

The content of the specific compound (xylitol, erythritol, or D-mannitol) can be determined from the relationship between the content (percent by mass) and the non-ejection period (s) after which good printed matter was produced, shown in FIGS. 6 to 8. The non-ejection period after which good printed matter was produced refers to the longest time of the period from the time of suspending the ejection of the ink i to the time of restarting the ejection after which good printed matter can be produced. The above-described line printer apparatus 1 takes about 12 seconds to print an A4-size image or document. In order to produce good printed matter, the line printer apparatus 1 ejects the ink i through the nozzles 27a for at least 12 seconds even if the image or document to be printed has a blank area. Accordingly, the content (lateral axis in FIGS. 6 to 8) of the compound can be determined in the range in which the non-ejection period after which good printed matter was produced is 12 seconds or more in FIGS. 6 to 8.

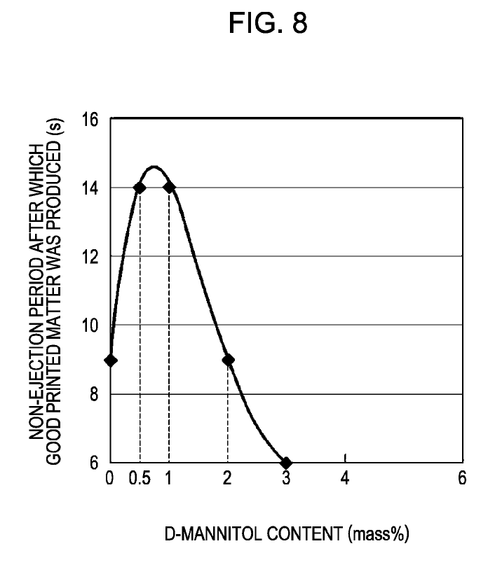

From the results shown in FIG. 6, the xylitol content (Y, mass %) can be set in the range of 0.25% to 3.0% by mass. From the results shown in FIG. 7, the erythritol content (Y, mass %) can be set in the range of 0.25% to 2.0% by mass. From the results shown in FIG. 8, the D-mannitol content (Y, mass %) can be set in the range of 0.5% to 1.0% by mass. Xylitol, erythritol and D-mannitol each have a heat of dissolution (Q₂₀) of lower than −10 kJ/mol in water at 20° C. and 10³ hPa, and exhibit a large difference (S₆₀−S₂₀) in solubility between 20° C. and 60° C. By adding xylitol, erythritol or D-mannitol to the ink i in an appropriate proportion, these compounds are dissolved in the ink i to reduce the viscosity of the ink i when the ink i is heated to 60° C. with the heat resistor 26a.

When the ink i having the above-described composition is not ejected through a nozzle 27a, it is dried to thicken in the nozzle 27a or at the end of the nozzle 27a. Thus, the contents of glycerol, the coloring agent and the specific compound in the ink composition are increased to increase the viscosity. In the ink i of the present embodiment, which contains a compound satisfying relationships (1) Q₂₀<−10 and (2) S₆₀−S₂₀>10, and exhibiting a large difference in solubility between 20° C. and 60° C., however, the solubility of the compound is increased by being heated with a heating mechanism, such as the heat resistor 26a, and thus the viscosity of the ink i is reduced. Hence, the viscosity of the ink i in the nozzle 27a or at the end of the nozzle 27a is recued, and consequently, the ink i is ejected properly through the nozzle 27a.

By using the ink i in the above-described printer apparatus 1, the printer apparatus 1 can eject ink properly to achieve continuous printing for 12 seconds or more for, for example, preparing an A4-size image or document, without cleaning the ejection surface 23a with the cleaning roller 24a with the head cap 24 covering the ejection surface 23a of the ink ejection head 23, or performing idle ejection of ink i in the head cap 24. Since the printer apparatus 1 can eject ink properly without cleaning or idle ejection during continuous printing for 12 seconds or more, the ink consumption can be reduced. Furthermore, the use of the ink i in the printer apparatus 1 reduces the load of maintenance and allows stable printing of the printer apparatus exhibiting superior ejection stability without clogging the nozzles 27a.

Although the above-described embodiment uses the ink i in the line printer apparatus 1, the ink i can be used without cleaning or performing idle ejection during continuous printing in serial printer apparatuses, which print a lien by moving the ink ejection head in the direction of the width of the recording paper P. Although, in the above-embodiment, the heat resistor 26a is used as a heating mechanism, the heating mechanism may be a piezoelectric element. Piezoelectric elements can help proper ejection as in the use of the heat resistor 26a.

### EXAMPLES

Specific examples of the invention will be described in detail with reference to the experimental results.

### Example 1

In Example 1, commercially available Direct Blue 199 was added in a concentration of 3% by mass to ion exchanged water, and the following ingredients were added: 10% by mass of glycerol; 0.5% by mass of Surfinol E1010 (produced by Nissin Chemical Industry) as surfactant; 3% by mass of 1,2-hexanediol as a penetrating agent; and 0.25% by mass of xylitol as the specific compound.

### Example 2

The ink composition of Example 2 was prepared in the same manner as in Example 1 except that 0.5% by mass of xylitol was used as the specific compound.

### Example 3

The ink composition of Example 3 was prepared in the same manner as in Example 1 except that 1.0% by mass of xylitol was used as the specific compound.

### Example 4

The ink composition of Example 4 was prepared in the same manner as in Example 1 except that 2.0% by mass of xylitol was used as the specific compound.

### Example 5

The ink composition of Example 5 was prepared in the same manner as in Example 1 except that 3.0% by mass of xylitol was used as the specific compound.

### Example 6

In Example 6, commercially available Direct Blue 199 was added in a concentration of 3% by mass to ion exchanged water, and the following ingredients were added: 10% by mass of glycerol; 0.5% by mass of Surfinol E1010 (produced by Nissin Chemical Industry) as surfactant; 3% by mass of 1,2-hexanediol as a penetrating agent; and 0.25% by mass of erythritol as the specific compound.

### Example 7

The ink composition of Example 7 was prepared in the same manner as in Example 6 except that 0.5% by mass of erythritol was used as the specific compound.

### Example 8

The ink composition of Example 8 was prepared in the same manner as in Example 6 except that 1.0% by mass of erythritol was used as the specific compound.

### Example 9

The ink composition of Example 9 was prepared in the same manner as in Example 6 except that 2.0% by mass of erythritol was used as the specific compound.

### Example 10

In Example 10, commercially available Direct Blue 199 was added in a concentration of 3% by mass to ion exchanged water, and the following ingredients were added: 10% by mass of glycerol; 0.5% by mass of Surfinol E1010 (produced by Nissin Chemical Industry) as surfactant; 3% by mass of 1,2-hexanediol as a penetrating agent; and 0.5% by mass of D-mannitol as the specific compound.

### Example 11

The ink composition of Example 11 was prepared in the same manner as in Example 10 except that 1.0% by mass of D-mannitol was used as the specific compound.

### Example 12

Commercially available Direct Blue 199 was added in a concentration of 3% by mass to ion exchanged water, and the following ingredients were added: 20% by mass of glycerol; 0.5% by mass of Surfinol E1010 (produced by Nissin Chemical Industry) as surfactant; 3% by mass of 1,2-hexanediol as a penetrating agent; and 1.0% by mass of xylitol as the specific compound.

### Example 13

The ink composition of Example 13 was prepared in the same manner as in Example 1 except that commercially available Direct Yellow 132 was added in a concentration of 3% by mass to ion exchanged water.

### Example 14

In Example 14, commercially available Direct Blue 199 was added in a concentration of 3% by mass to ion exchanged water, and the following ingredients were added: 20% by mass of glycerol; 0.5% by mass of Surfinol E1010 (produced by Nissin Chemical Industry) as surfactant; 3% by mass of hexylene glycol as a penetrating agent; and 1% by mass of xylitol as the specific compound.

### Comparative Example 1

In Comparative Example 1, commercially available Direct Blue 199 was added in a concentration of 3% by mass to ion exchanged water, and the following ingredients were added: 10% by mass of glycerol; 0.5% by mass of Surfinol E1010 (produced by Nissin Chemical Industry) as surfactant; and 3% by mass of 1,2-hexanediol as a penetrating agent. No specific compound was added.

### Comparative Example 2

The ink composition of Comparative Example 2 was prepared in the same manner as in Example 1 except that 4.0% by mass of xylitol was used as the specific compound.

### Comparative Example 3

The ink composition of Comparative Example 3 was prepared in the same manner as in Example 1 except that 5.0% by mass of xylitol was used as the specific compound.

### Comparative Example 4

The ink composition of Comparative Example 4 was prepared in the same manner as in Example 6 except that 3.0% by mass of erythritol was used as the specific compound.

### Comparative Example 5

The ink composition of Comparative Example 5 was prepared in the same manner as in Example 6 except that 4.0% by mass of erythritol was used as the specific compound.

### Comparative Example 6

The ink composition of Comparative Example 6 was prepared in the same manner as in Example 10 except that 2.0% by mass of D-mannitol was used as the specific compound.

### Comparative Example 7

The ink composition of Comparative Example 7 was prepared in the same manner as in Example 10 except that 3.0% by mass of D-mannitol was used as the specific compound.

### Comparative Example 8

The ink composition of Comparative Example 8 was prepared in the same manner as in Example 1 except that 1.00 by mass of maltitol was used as a specific compound.

### Comparative Example 9

The ink composition of Comparative Example 9 was prepared in the same manner as in Example 1 except that 1.00 by mass of sucrose was used as a specific compound.

### Comparative Example 10

In Comparative Example 10, commercially available Direct Yellow 132 was added in a concentration of 3% by mass to ion exchanged water, and the following ingredients were added: 30% by mass of glycerol; 0.5% by mass of Surfinol E1010 (produced by Nissin Chemical Industry) as surfactant; 3% by mass of 1,2-hexanediol as a penetrating agent; and 1.0% by mass of xylitol as the specific compound.

All the ink compositions prepared above were filtered through a filter of 2 μm in pore size, and evaluated as below. The specific compounds used in the ink compositions each have a heat of dissolution (Q₂₀) in water at 20° C. and 10³ hPa, a solubility in water at 20° C. (S₂₀), and a solubility in water at 60° C. (S₆₀), shown in Table 1.

All the ink compositions were subjected to tests for the non-ejection period after which good printed mater can be produced, using a line head ink jet printer LPR-E5000 and its print head (manufactured by Sony Corporation). The test was performed under the condition where the ink in the vicinities of the nozzles was heated to 60° C. with heat resistors. The test results are shown in Table 2. The non-ejection period after which good printed matter was produced refers to the longest time of the period from the time of suspending the ejection of the ink i to the time of restarting the ejection after which good printed matter was produced.

TABLE 2

| | | | Non-ejection | |
|---|---|---|---|---|
| | | | period after which | |
| | | | good printed | Water |
| | Specific | Content | matter was | content |
| | compound | (mass %) | produced (s) | (mass %) |
| Example 1 | Xylitol | 0.25 | 12 | 83.25 |
| Example 2 | Xylitol | 0.50 | 21 | 83.00 |
| Example 3 | Xylitol | 1.00 | 28 | 82.50 |
| Example 4 | Xylitol | 2.00 | 25 | 81.50 |
| Example 5 | Xylitol | 3.00 | 14 | 80.50 |
| Example 6 | Erythritol | 0.25 | 13 | 83.25 |
| Example 7 | Erythritol | 0.50 | 15 | 83.00 |
| Example 8 | Erythritol | 1.00 | 16 | 82.50 |
| Example 9 | Erythritol | 2.00 | 13 | 81.50 |
| Example 10 | D-Mannitol | 0.50 | 14 | 83.00 |
| Example 11 | D-Mannitol | 1.00 | 14 | 82.50 |
| Example 12 | Xylitol | 1.00 | 18 | 72.50 |
| Example 13 | Xylitol | 1.00 | 20 | 83.25 |
| Example 14 | Xylitol | 1.00 | 24 | 72.50 |
| Comparative | None | | 9 | 83.50 |
| Example 1 | | | | |
| Comparative | Xylitol | 4.00 | 9 | 79.50 |
| Example 2 | | | | |
| Comparative | Xylitol | 5.00 | 8 | 78.50 |
| Example 3 | | | | |
| Comparative | Erythritol | 3.00 | 10 | 80.50 |
| Example 4 | | | | |
| Comparative | Erythritol | 4.00 | 9 | 79.50 |
| Example 5 | | | | |
| Comparative | D-Mannitol | 2.00 | 9 | 81.50 |
| Example 6 | | | | |
| Comparative | D-Mannitol | 3.00 | 6 | 80.50 |
| Example 7 | | | | |
| Comparative | Maltitol | 1.00 | 9 | 82.50 |
| Example 8 | | | | |
| Comparative | Sucrose | 1.00 | 9 | 82.50 |
| Example 9 | | | | |
| Comparative | Xylitol | 1.00 | 6 | 62.50 |
| Example 10 | | | | |

As shown in Table 2, the non-ejection period of Comparative Example 1 after which good printed matter was produced was 9 seconds because it did not contain a compound having a large difference in solubility between temperatures. The result of Comparative Example 1 suggests that, if the ink of Comparative Example 1 is not ejected over a period of 9 seconds or more, for example, proper ejection may not be performed.

Comparative Examples 2 to 7 contained xylitol, erythritol or D-mannitol, which have a heat of dissolution in water of less than −10 kJ/mol at 20° C. and 10³ hPa and exhibits a large difference in solubility between temperatures. However, their contents were excessively high or low, and the non-ejection period after which good printed matter was produced did not attain 12 seconds or more.

Comparative Example 8 contained 1.0% by mass of maltitol that has a solubility satisfying relationship (2) and a heat of dissolution not satisfying relationship (1). Accordingly, the non-ejection period after which good printed matter was produced was 9 seconds. This was shorter than the Examples containing a compound satisfying relationships (1) and (2).

Comparative Example 9 contained 1.0% by mass of sucrose having a heat of dissolution and solubility not satisfying relationships (1) and (2). Accordingly, the non-ejection period after which good printed matter was produced was 9 seconds. This was shorter than the Examples containing a compound satisfying relationships (1) and (2).

Comparative Example 10 contained 30% by mass of glycerol; hence the water content was less than 70% by mass. Accordingly, the ink had a high viscosity, and the non-ejection period after which good printed matter was produced was reduced to 6 seconds even though xylitol was added.

On the other hand, Examples 1 to 14 contained any one of xylitol, erythritol and D-mannitol satisfying relationships (1), (2) and (3). By heating these inks to 60° C. before ejection, the solubility of the xylitol, erythritol or D-mannitol was increased to reduce the viscosity of the inks.

The inks of Examples 1 to 14 thus can be properly ejected to produce a good image even after the ejection was suspended for 12 seconds or more.

The inks of Examples 2 to 4 and 13 and 14 exhibited non-ejection periods of 20 seconds or more, and thus proper ejection can be restarted to produce good printed matter even after the ejection was suspended for 20 seconds more. Thus, the continuous printing time can be increased. The inks of Examples 2 to 4 and 13 and 14 allow continuous printing for about 20 seconds without cleaning the ink ejection head or performing idle ejection. Even if printing is performed for a longer time than 20 seconds, the number of times of cleaning or idle ejection can be reduced.

The present application contains subject matter related to that disclosed in Japanese Priority Patent Application JP 2009-161954 filed in the Japan Patent Office on Jul. 8, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A recording liquid ejected by a liquid ejection apparatus including a liquid ejection head having a nozzle through which the recording liquid is ejected and a heating mechanism heating the recording liquid around the nozzle to about 60° C., the recording liquid comprising:
70% by mass to less than 90% by mass of water;
glycerol;
a coloring agent soluble or dispersible in the water; and
0.25% to 3.0% by mass of xylitol.

2. A recording liquid ejected by a liquid ejection apparatus including a liquid ejection head having a nozzle through which the recording liquid is ejected and a heating mechanism heating the recording liquid around the nozzle to about 60° C., the recording liquid comprising:
70% by mass to less than 90% by mass of water;
glycerol;
a coloring agent soluble or dispersible in the water; and
0.25% to 2.0% by mass of erythritol.

3. A recording liquid ejected by a liquid ejection apparatus including a liquid ejection head having a nozzle through which the recording liquid is ejected and a heating mechanism heating the recording liquid around the nozzle to about 60° C., the recording liquid comprising:
70% by mass to less than 90% by mass of water;
glycerol;
a coloring agent soluble or dispersible in the water; and
0.5% to 1.0% by mass of D-mannitol.

4. A recording liquid ejected by a liquid ejection apparatus including a liquid ejection head having a nozzle through which the recording liquid is ejected and a heating mechanism heating the recording liquid around the nozzle to about 60° C., the recording liquid comprising:
70% by mass to less than 90% by mass of water;
glycerol;
a coloring agent soluble or dispersible in the water; and
a compound having a hydroxy group in an amount satisfying relationship (3), the compound being solid at ordinary temperature and pressure and satisfying the following relationships (1) and (2):
Q₂₀<−10 (1)
S₆₀−S₂₀>10 (2)
0.25<Y<S₆₀÷2500 (3)
wherein Q₂₀ represents a heat of dissolution of the compound in water at 20° C. and 10³ hPa on a KJ/mol basis, S₂₀ represents the solubility of the compound at 20° C. in water, S₆₀ represents the solubility of the compound at 60° C. in water, and Y represents the content of the compound on a percent by mass basis, wherein the solubility refers to the mass on a gram basis of the compound in 100 g of saturated solution of the compound.

5. The recording liquid according to claim 4, wherein the solubility S₂₀ of the compound at 20° C. in water is 60% by mass or more.

6. The recording liquid according to claim 5, wherein the glycerol content is in the range of 10% to 20% by mass.

7. The recording liquid according to any one of claims 1 to 4, wherein the heating mechanism includes a heat resistor, and the recording liquid is ejected through the nozzle by being compressed with the heat resistor.

8. The recording liquid according to claim 7, wherein the recording liquid is ejected onto a recording medium through a plurality of nozzles of the liquid ejection head, the nozzles being arranged in a line extending in a direction perpendicular to the direction in which the recording medium is transported, the line of the nozzles having a length corresponding to the maximum width of the recording medium.
